(19) United States
(12) Patent Application Publication
(10) Pub. No.: US 2011/0114201 A1
(43) Pub. Date: May 19, 2011

(54) Temperature Sensitive Relief Valve

(75) Inventor: Eric Winter, Evesham (GB)

(73) Assignee: GSA Industries (Aust.) Pty Ltd., Melbourne (AU)

(21) Appl. No.: 12/944,886

(22) Filed: Nov. 12, 2010

(30) Foreign Application Priority Data
Nov. 12, 2009 (GB) 0919793.0

(51) Int. Cl. F16K 15/00; F16K 1/00

(52) U.S. Cl. 137/468; 137/596; 251/324

(57) ABSTRACT

A temperature sensitive relief valve for a reservoir of a hot fluid including a cold fluid inlet in communication with a cold fluid outlet via a main cold fluid feed arrangement; a fluid mixing chamber having an outlet; a hot fluid inlet adapted for attachment to the reservoir of hot fluid and in communication with the fluid mixing chamber; a secondary cold fluid feed arrangement in communication with the fluid mixing chamber; and a valve arrangement responsive to the temperature of the hot fluid in the reservoir so that, when the temperature of the hot fluid is below a pre-determined value, the valve arrangement is in a first configuration which prevents hot fluid and cold fluid from entering the fluid mixing chamber and, when the temperature of the hot fluid exceeds the pre-determined value, the valve arrangement adopts a second configuration which allows hot fluid and cold fluid to enter the fluid mixing chamber, thereafter to flow out of the outlet of the fluid mixing chamber as a mixed fluid having a temperature less than the temperature of the hot fluid.

### CROSS-REFERENCE TO RELATED APPLICATIONS

This application claims the benefit of Great Britain Patent Application No. GB0919793.0 filed on Nov. 12, 2009.

### TECHNICAL FIELD OF THE INVENTION

This invention relates to a temperature sensitive relief valve for fluids, with particular, but by no means exclusive, reference to a relief valve for use with reservoirs of hot water in the water supply system of a building.

### BACKGROUND OF THE INVENTION

Most buildings, whether domestic or otherwise, utilise some form of water supply system, and typically hot water services are provided. Reservoirs of hot water, such as boilers, can fail with potentially catastrophic consequences if the temperature and/or pressure of the water exceeds safe limits. For this reason, it is known to provide pressure and temperature relief valves on hot water reservoirs such as boilers. These pressure and temperature relief valves are connected to an exhaust system for removing hot water vented through the relief valve. Typically, it is recommended that copper pipework is used, the copper pipework being connected to a common, larger diameter drain, which is then piped away to storm water. Copper pipework is expensive and increasingly subject to theft. The present inventor has appreciated that in practice, the recommended system based on copper pipework is abandoned. Instead, it has become common for pressure and temperature relief valves to be piped into the soil stack. This is extremely undesirable, because soil stack plumbing typically comprises plastic pipes which are not suitable for exhausting high temperature water. The present inventor is aware of instances where the plastic pipe has failed, with severe attendant consequences.

The present invention, in at least some of its embodiments, addresses the above described problems, and provides a temperature relief valve which can be safely used in conjunction with plastic relief exhaust plumbing systems, thereby permitting, for example, safe connection with the soil stack.

### SUMMARY OF THE INVENTION

According to a first aspect of the invention there is provided a temperature sensitive relief valve for a reservoir of a hot fluid including a cold fluid inlet in communication with a cold fluid outlet via a main cold fluid feed arrangement; a fluid mixing chamber having an outlet; a hot fluid inlet adapted for attachment to the reservoir of hot fluid and in communication with the fluid mixing chamber; a secondary cold fluid feed arrangement in communication with the fluid mixing chamber; a valve arrangement responsive to the temperature of the hot fluid in the reservoir so that, when the temperature of the hot fluid is below a pre-determined value, the valve arrangement is in a first configuration which prevents hot fluid and cold fluid from entering the fluid mixing chamber and, when the temperature of the hot fluid exceeds the pre-determined value, the valve arrangement adopts a second configuration which allows hot fluid and cold fluid to enter the fluid mixing chamber, thereafter to flow out of the outlet of the fluid mixing chamber as a mixed fluid having a temperature less than the temperature of the hot fluid.

In preferred embodiments, the valve arrangement is a piston assembly including a piston and a piston actuating arrangement which causes the piston to be moved from the first configuration to the second configuration when the temperature of the hot fluid exceeds the pre-determined value. Advantageously, the piston actuating arrangement includes a substance which expands and contracts in a response to a change in temperature of the hot fluid in the reservoir. The substance may be any suitable substance, and may be a pure substance or a composition having a number of constituents. Preferred examples of suitable substances are a wax (such as a paraffin wax), a wax containing composition (such a wax/copper mixture) or a plastic (such as polyethylene).

Alternatively, the valve arrangement may include one or more other thermostats or temperature sensors which are in operative connection with one or more valve parts which regulate the flow of hot and cold fluid into the fluid mixing chamber. Typically, the valve arrangement is mechanical in structure. However, it is envisaged that electronic valve arrangements in which the output of one or more temperature sensors is used to control the movement of one or more valve parts might be utilised. Electronic actuators or electric motors in combination with a suitable control system might be provided for this purpose.

Typically, the temperature sensitive relief valve is used as part of a pressure and temperature relief valve system. In a preferred embodiment, the temperature sensitive relief valve also provides a pressure relief capability. In these embodiments, the temperature sensitive relief valve is operable as a combined pressure and temperature relief valve, wherein the main cold fluid feed arrangement is in communication with a pressure relief valve. In these embodiments, the valve of the invention acts as combined, one-piece pressure and temperature relief valve.

In other embodiments, a pressure relief valve is provided which is separate from the temperature sensitive relief valve of the invention. In use, the pressure relieve valve may be directly or indirectly coupled to the temperature sensitive relief valve. In this way, a two-piece pressure and temperature relief valve assembly can be provided.

In either one-piece or two-piece embodiments, the main cold fluid feed arrangement of the temperature sensitive relief valve may be provided with a fitting enabling connection of the cold fluid in the main cold fluid feed arrangement to an expansion vessel.

The main cold fluid feed arrangement may include a one-way valve.

Generally, the temperature sensitive relief valve includes a main body portion which can be formed from any suitable material, such as a metal.

According to a second aspect of the invention, there is provided a fluid supply system including a reservoir of a hot fluid, a cold fluid supply system, and a temperature sensitive relief valve according to the first aspect of the invention, wherein the temperature sensitive relief valve is attached to the reservoir and is coupled into the cold fluid supply system, and in which the outlet of the fluid mixing chamber is in communication with a fluid exhaust arrangement.

Advantageously, the fluid exhaust arrangement is a soil stack. Alternatively, or additionally, the fluid exhaust arrangement may be formed from a plastics material.

Although the invention has been described above, it extends to any inventive combination of features set above or in the following description, drawings and claims.

### BRIEF DESCRIPTION OF THE DRAWINGS

FIG. 1 is a perspective view of a temperature sensitive relief valve of the invention;

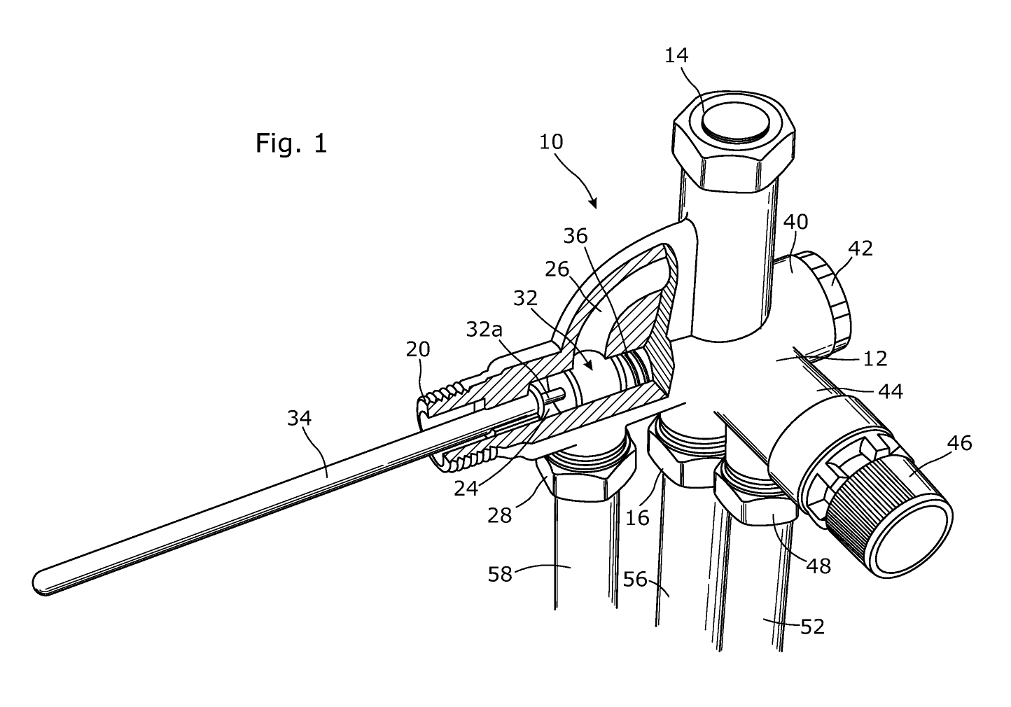

FIG. 2 is a partially cut-away side view of the temperature sensitive relief valve of FIG. 1 connected to a boiler;

FIG. 3 is a partially cut-away plan view of the temperature sensitive relief valve of FIG. 1 connected to a boiler;

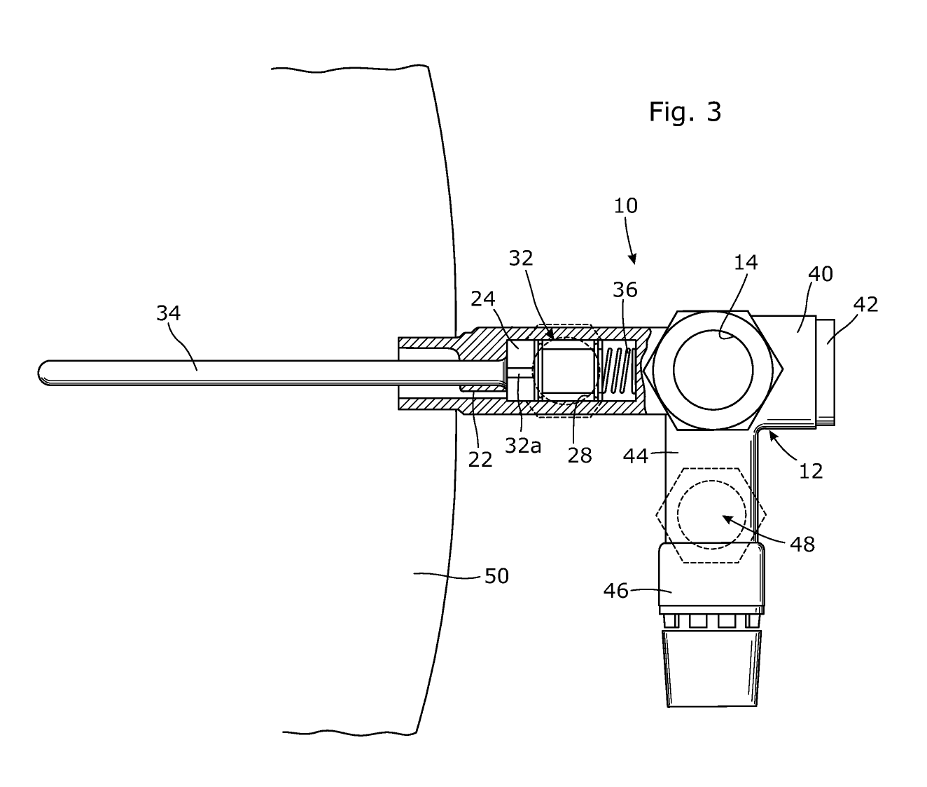

FIG. 4 is a side view of the temperature sensitive relief valve of FIG. 1 when viewed from the expansion connection side; and

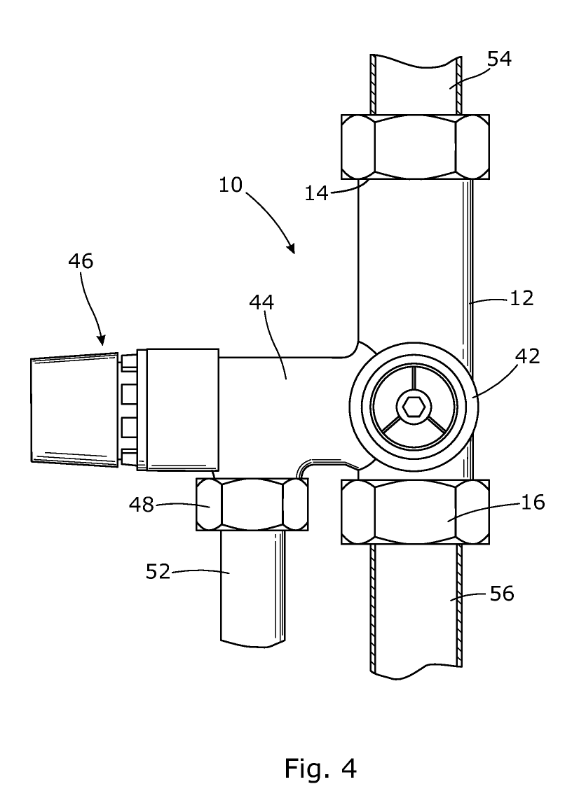

FIG. 5 is a partially cut-away side view of the temperature sensitive relief valve of FIG. 1 in connected with a boiler under excess water temperature operating conditions.

### DETAILED DESCRIPTION OF THE INVENTION

The Figures show a temperature sensitive relief valve, depicted generally 10, of the invention. As explained in more detail below, the relief valve 10 also functions as a pressure valve in this embodiment, and therefore can be considered as a pressure and temperature relief valve. The relief valve 10 comprises a main body 12 having a cold water inlet 14 and a cold water outlet 16. The main body 12 defines a main cold water conduit 18 which extends between the cold water inlet 14 and cold water outlet 16. The relief valve 10 further comprises a hot water inlet 20 which is designed so as to be attached to a desired source of hot water, such as a hot water boiler. The main body 12 defines an interior passageway 22 which extends between the hot water inlet 20 and a mixing chamber 24 contained within the main body 12. The main body 12 further comprises a secondary cold water conduit 26 which extends from the main cold water conduit 18 to the mixing chamber 24. The secondary cold water conduit 26 is in the form of a side-passage from the main cold water conduit 18 which acts to channel a portion of the main cold water feed to the mixing chamber 24. The main body 12 further comprises a mixing chamber outlet 28 which is in communication with the mixing chamber 24 via a conduit 30. A piston valve 32 is disposed in the mixing chamber 24. A stem 32a of the piston valve 32 extends into a temperature sensor 34 which is partially disposed in a hot water boiler 50.

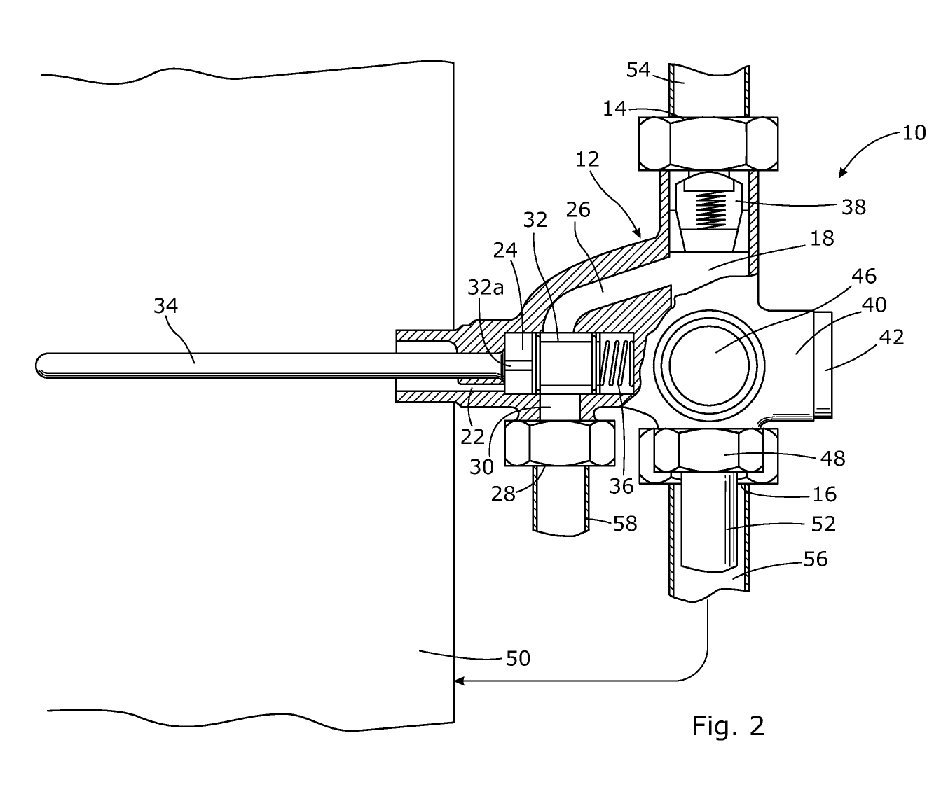

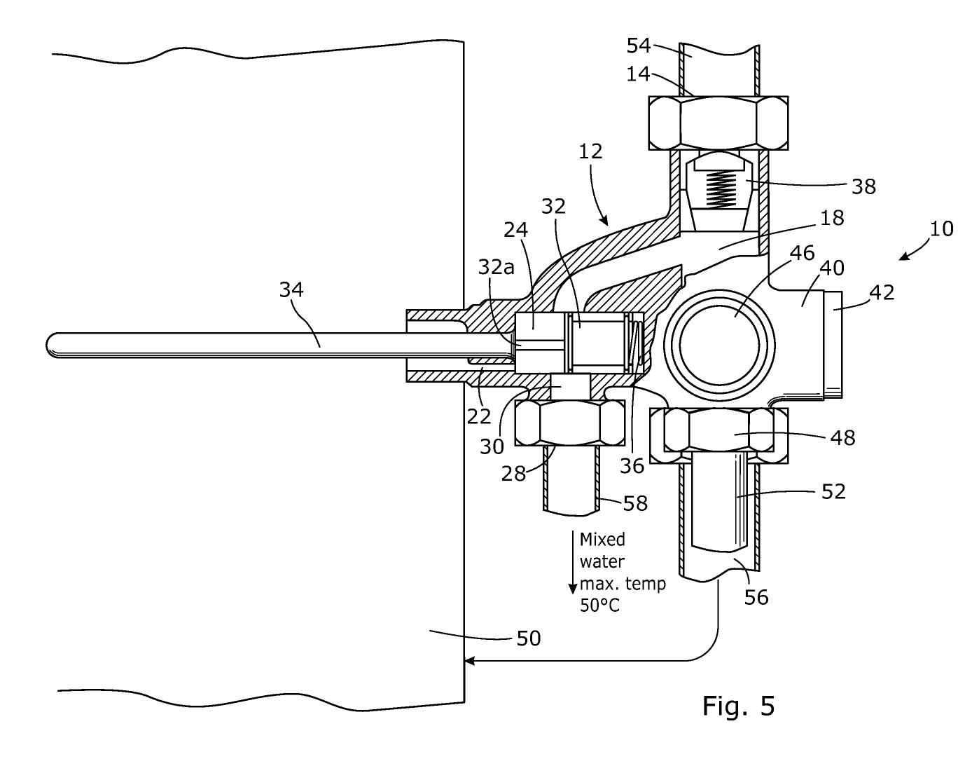

In ordinary use, the piston valve 32 is disposed within the mixing chamber 24 so as to prevent hot water entering the hot water inlet 20 and cold water in the secondary cold water conduit 26 from flowing out of the mixing chamber outlet 28 via conduit 30. The temperature sensor 34 is configured to cause the piston valve 32 to move further into the mixing chamber 24 should be the temperature of the hot water in the boiler 50 exceed a pre-determined, alarm temperature. Conveniently, this can be achieved by using a temperature sensor of the type comprising a tube or other suitable receptacle housing a substance such as a wax which expands and contracts in response to changes in temperature. In one non-limiting embodiment, the temperature sensor 34 includes a paraffin wax which melts and expands at temperatures in excess of 95° C. This expansion causes the piston valve 32 to move further into the mixing chamber 24. This configuration is shown in FIG. 5, and corresponds to actual operation of the relief valve under emergency conditions of excessively high temperature. The skilled reader will appreciate that in the configuration shown in FIG. 5, both hot water, entering the mixing chamber 24 from the hot water inlet 20, and cold water, entering the mixing chamber 24 from the secondary cold water conduit 26, are able to mix in the mixing chamber 24 and then exit the same via the mixing chamber outlet 28. A suitable biasing device such as a spring 36 is disposed in the mixing chamber 24 so as to urge the piston valve 30 back into the normal configuration shown in FIG. 2 once the temperature of the hot water in the boiler 50 drops and the wax in the temperature sensor 34 contracts. The relief valve 10 further comprises a one-way valve 38 which is disposed in the main cold water conduit 18 upstream of the secondary cold water conduit 26.

The embodiment shown in the Figures can also operate as a pressure relief valve by virtue of further features which are now described. In particular, downstream of the junction with the secondary cold water conduit 26, the main cold water conduit 18 is in connection with two further side-passageways. An expansion conduit 40 is in communication with and extends from the main cold water conduit 18, and terminates in a fitting 42 suitable for connection to an expansion vessel (not shown). A pressure relief conduit 44 is in communication with and extends from the main cold water conduit 18, and serves as a housing for a pressure relief valve 46 of known type. The pressure relief conduit 44 also extends to a pressure relief outlet 48. The fitting 42 and pressure relief valve 46 are selected so that, in the event of an over-pressure, excess pressure would first be accommodated through the expansion vessel. The pressure relief valve 46 is set to be activated by a still higher excess pressure. Once activated, the pressure relief valve permits excess water pressure to be relieved by way of diverting water through the pressure relief outlet 48 to a pressure relief line 52.

The relief valve 10 can be conveniently plumbed into conventional water systems. The cold water inlet and cold water outlet of the relief valve can be conveniently plumbed into the cold water feed downstream of a pressuring pump. In the Figures, connections to cold water feeds 54, 56 are shown. The hot water inlet of the relief valve can be conveniently plumbed into a hot water storage device such as a hot water boiler. Suitable connections, such as suitably sized threads and locking nuts, can be provided to enable the relief valve to be plumbed into conventional systems, as will readily occur to the skilled reader. The mixing chamber outlet is connected to a suitable outflow line 58.

The piston valve 32 is actuated by the temperature sensor 34 once an excess hot water temperature is reached. As discussed above, the actuation of the piston valve 32 causes hot and cold water streams to enter the mixing chamber 24. It will be apparent that the effect of this mixing is to reduce the temperature of the hot water entering the mixing chamber 24. Therefore, the temperature of the mixed water exiting the mixing chamber outlet 28 in the event of an emergency condition is reduced in comparison to the excess temperature of the water in the boiler 50. A proportion of the cold water flowing through the main cold water conduit 18 is, in the event of an emergency situation, diverted along the secondary cold water conduit 26 into the mixing chamber 24. The design of the secondary cold water conduit 26, mixing chamber 24, piston valve 32, and interior passageway 22 can be routinely optimised in order to achieve a desired mixing ratio. In general, a mixing ratio of around 50:50 (by volume) is considered desirable, but it will be apparent to the skilled reader that other mixing ratios might be employed. The relief valve design generally shown in the Figures can be used to achieve a water temperature of the mixed water exiting the mixing chamber outlet 28 of around 50° C. or less. A considerable advantage of this is that the mixing chamber outlet of the relief valve can be safely connected to outflows formed from plastic materials or other materials which are not suitable to withstand high water temperatures of 95° C. or more. As a result, the relief valves of the present invention can be safely connected to the soil stack and do not require the provision of expensive outflow plumbing such as copper piping.

Numerous variations to the designs and methodologies discussed are possible. For example, it is possible to vary the size and shape of the piston valve in order to optimise the flow of hot and cold water into the mixing chamber. The size and shape of the conduits which are in direct communication with the mixing chamber can also be varied. The embodiment shown in the Figures is a “one-piece” pressure and temperature relief valve. Alternatively, it is possible to provide a “two-piece” device wherein one piece is a dedicated temperature sensitive relief valve of the invention, and the second piece is a dedicated pressure relief valve. The two pieces can be connected either directly or indirectly.

What is claimed is:

1. A temperature sensitive relief valve for a reservoir of a hot fluid comprising:
a cold fluid inlet in communication with a cold fluid outlet via a main cold fluid feed arrangement;
a fluid mixing chamber having an outlet;
a hot fluid inlet adapted for attachment to the reservoir of hot fluid and in communication with the fluid mixing chamber;
a secondary cold fluid feed arrangement in communication with the fluid mixing chamber;
a valve arrangement responsive to the temperature of the hot fluid in the reservoir so that, when the temperature of the hot fluid is below a pre-determined value, the valve arrangement is in a first configuration which prevents hot fluid and cold fluid from entering the fluid mixing chamber and, when the temperature of the hot fluid exceeds the pre-determined value, the valve arrangement adopts a second configuration which allows hot fluid and cold fluid to enter the fluid mixing chamber, thereafter to flow out of the outlet of the fluid mixing chamber as a mixed fluid having a temperature less than the temperature of the hot fluid.

2. A temperature sensitive relief valve according to claim 1 in which the valve arrangement is a piston assembly including a piston and a piston actuating arrangement which causes the piston to be moved from the first configuration to the second configuration when the temperature of the hot fluid exceeds the pre-determined value.

3. A temperature sensitive relief valve according to claim 2 in which the piston actuating arrangement includes a substance which expands and contracts in response to a change in temperature of the hot fluid in the reservoir.

4. A temperature sensitive relief valve according to claim 3 in which the substance is a wax or a wax containing composition.

5. A temperature sensitive relief valve according to claim 1 which is operable as a combined pressure and temperature relief valve, wherein the main cold fluid feed arrangement is in communication with a pressure relief valve.

6. A temperature sensitive relief valve according to claim 5 in which the main cold fluid feed arrangement includes a one-way valve.

7. A fluid supply system comprising a reservoir of a hot fluid, a cold fluid supply system, and a temperature sensitive relief valve, wherein the temperature sensitive relief valve is attached to the reservoir and is coupled into the cold fluid supply system, and in which the outlet of the fluid mixing chamber is in communication with a fluid exhaust arrangement.

8. A fluid supply system according to claim 7 in which the fluid exhaust arrangement is a soil stack and/or is formed from a plastics material.

9. A relief valve comprising:
a main body having a cold water inlet and a cold water outlet having a primary cold water conduit therebetween;
a hot water inlet connected to a source of hot water;
an interior passageway extending between the hot water inlet and a mixing chamber having an outlet;
a secondary cold water conduit connecting the primary cold water conduit to the mixing chamber;
a piston valve disposed within the mixing chamber, the piston valve including a stem having a temperature sensor, wherein the piston valve regulates the flow of hot water from the hot water inlet into the mixing chamber where the hot water can then mix with cold water from the secondary cold water inlet before the mixture exits the mixing chamber through the outlet.
